(19) United States
(12) Patent Application Publication
(10) Pub. No.: US 2005/0204046 A1
(43) Pub. Date: Sep. 15, 2005

(54) Data transmitting apparatus, data receiving apparatus, data transmitting manner, and data receiving manner

(76) Inventor: Takahiro Watanabe, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/515,257

(22) PCT Filed: Jun. 19, 2003
(86) PCT No.: PCT/JP03/07762

§ 371 Date: Nov. 23, 2004

(30) Foreign Application Priority Data
Jun. 20, 2002 (JP) 2002-180046

(51) Int. Cl. G06F 15/16

(52) U.S. Cl. 709/228; 709/232

(57) ABSTRACT

A data receiving apparatus 200 transmits, to a data transmitting apparatus 400, a content ID, a compression method and an extent of a bit rate (S1201). The data transmitting apparatus 400 specifies the compression method and the bit rate and replies to the data receiving apparatus 200 (S1202). The data transmitting apparatus 400 performs decoding of content by the compression method and starts a distribution of content at the bit rate (S1207). During this time, when receiving a “bit rate change request” from the data receiving apparatus 200 (S1208), the data transmitting apparatus 400 notifies, to the data receiving apparatus 200, by determining a new bit rate (S1210) and restarts the content distribution at the changed bit rate (S1213 to S1215).

### TECHNICAL FIELD

The present invention relates to a digital communication technology, in particular to a technology for transmitting and receiving digital content between a multimedia terminal and a content server that are connected to a communication network.

### BACKGROUND ART

In recent years, following to a development of Internet, a distribution of contents such as video and music that target users of a personal computer and a personal digital assistant has been increasing. Behind the scene, there were a broadband of an Internet communication network including a radio communication, maintenances of a communication environment and a mobile communication network that are allowed for a continuous connection, a development of data compression technology, and an improvement of an integration technology.

On the other hand, there is a problem of a bad communication efficiency in consequences with a quantitative access concentration to a particular content server and a temporal access concentration during a particular time period. To avoid this problem, several methods are suggested. For example, methods of changing a bandwidth according to a density of communication include SureStream (SureStream is a registered trademark of Real Networks, Inc.), Intelligent Streaming (Intelligent Streaming is a registered trademark of Microsoft Corporation), and “Data Transmitting and Receiving System and Data Transmitting and Receiving Method, and Data Receiving Apparatus and Data Receiving Method” disclosed in Japanese Laid-Open Patent application No. 11-127150. Corresponding to an effective value of a bandwidth usable in a communication path, they control a bit rate between a terminal and a server. In other words, the server supervises a density in the communication path and controls a bandwidth according to the density.

However, the conventional method does not control a bandwidth according to a change of a processing state for each terminal which changes momentarily. In the case where a capacity to be allocated for receiving content is reduced, the method cannot follow the bit rate of the server so that the content cannot be received during the processing. Further, distributing content to terminals which have totally different capacity for processing data requires to prepare in advance a content coded by a compression method applicable to each terminal and transmit at a bit rate applicable to each terminal. In this case, a problem of increasing a storage capacity of the server also occurs.

For example, it applies to the case that, when a digital television is receiving a distribution of image content, a reserved recording for a program by terrestrial broadcasting is started in the back while receiving and playing the video content at the bit rate of 20 Mbps so that the reception of the video content and the recording processing by terrestrial broadcasting have to be executed at the same time. Also, it applies to the case that, when the same content data is transmitted to the digital television with a receiving capacity of 20 Mbps and a cellular phone with a receiving capacity of 384 Kbps, the conventional method has to store the content by different compression methods into storage devices of the servers (it includes the case where content has to be stored in a different data format since a bit rate at the time of transmission is different).

### DISCLOSURE OF INVENTION

Considering above mentioned problems, the object of the present invention is to provide a data transmitting and receiving method capable of reducing the storage area for storing contents at a server while avoiding the cases where the terminals cannot receive contents because the server and the terminal have a different compression method of a content to be distributed and a different bit rate at the distribution.

In order to achieve the above objective, the present invention is a data transmitting apparatus that distributes a predetermined digital content to a data receiving apparatus in response to a request from the data receiving apparatus, comprising: a communication setting value receiving unit operable to receive, from the data receiving apparatus, information for determining a communication setting value that indicates a rule for performing communication; a communication setting value determining unit operable to determine a communication setting value for a distribution of the digital content based on the received information; a communication setting value transmitting unit operable to transmit the determined communication setting value to the data receiving apparatus; and a data transmitting unit operable to transmit the digital content to the data receiving apparatus in accordance with the determined communication setting value.

Consequently, the data transmitting apparatus distributes content by specifying a communication setting value in response to a request from the data receiving apparatus so that it can more effectively transmit the content.

Also, in order to achieve the above objective, the present invention is a data receiving apparatus that receives a distribution of a digital content from a data transmitting apparatus, comprising: a communication setting value transmitting unit operable to transmit, to the data transmitting apparatus, information for determining a communication setting value that indicates a rule for performing communication; a communication setting value receiving unit operable to receive the communication setting value from the data transmitting apparatus; and a data receiving unit operable to receive digital content from the data transmitting apparatus in accordance with the received communication setting value.

Consequently, the data receiving apparatus notifies, in advance, the data transmitting apparatus information relating the receivable communication setting value to the data transmitting apparatus and receives content at the communication setting value specified by the data transmitting apparatus so that it can receive more efficiently the distribution of the content.

Further, to achieve the above object, the present invention can be realized as a data transmitting method, a data receiving method and a data transmitting and receiving method that include, as steps, characteristic units of the data transmitting apparatus and the data receiving apparatus, as well as realized as a program that includes all those steps. Then, the program can not only be stored in a ROM and the like in the data transmitting apparatus and the data receiving apparatus but also can be transmitted via a recording medium such as CD-ROM and a transmitting medium such as a communication network. Also, it can be realized as a data transmitting and receiving system comprising the data transmitting apparatus and the data receiving apparatus.

### BRIEF DESCRIPTION OF DRAWINGS

FIG. 1 is a block diagram showing an overview of a data transmitting and receiving system in the first embodiment.

FIG. 2 is a diagram showing a hardware configuration of a data receiving apparatus in the first embodiment.

FIG. 3 is a diagram showing a hardware configuration of a data transmitting apparatus in the first embodiment.

FIG. 4 is a structural example of a compression method table stored in a file device of the data receiving apparatus shown in FIG. 2.

FIG. 5 is a structural example of a compression method table stored in a file device of the data receiving apparatus shown in FIG. 3.

FIG. 6 is a structural example of a content table stored in a file device of the data transmitting apparatus shown in FIG. 3.

FIG. 7 is a block diagram showing a functional structure of a data receiving apparatus and a flow of data in the first embodiment.

FIG. 8 is a block diagram showing a functional structure of a data transmitting apparatus and a flow of data in the first embodiment.

FIG. 9 is a communication sequence diagram between the data receiving apparatus and the data transmitting apparatus in the first embodiment.

FIG. 10 is a flowchart showing a flow of processing in the data receiving apparatus in the case where the communication shown in FIG. 9 is performed.

FIG. 11 is a flowchart of a “receiving condition change processing” shown in FIG. 10.

FIG. 12 is a flowchart showing a flow of processing by the data transmitting apparatus in the case where the communication shown in FIG. 9 is performed.

FIG. 13 is a flowchart of a “distribution condition change processing” shown in FIG. 12.

FIG. 14 is a communication sequence diagram showing an interaction in the case where the data receiving apparatus specifies a compression method/a bit rate again since the compression method/the bit rate specified at first by the data receiving apparatus cannot distribute content.

FIG. 15 is a diagram showing a hardware configuration of a data receiving apparatus according to the second embodiment.

FIG. 16 is a block diagram showing a functional structure of the data receiving apparatus and a flow of data according to the second embodiment.

### BEST MODE FOR CARRYING OUT THE INVENTION

Hereafter explains about embodiments according to the present invention with reference to figures.

### First Embodiment

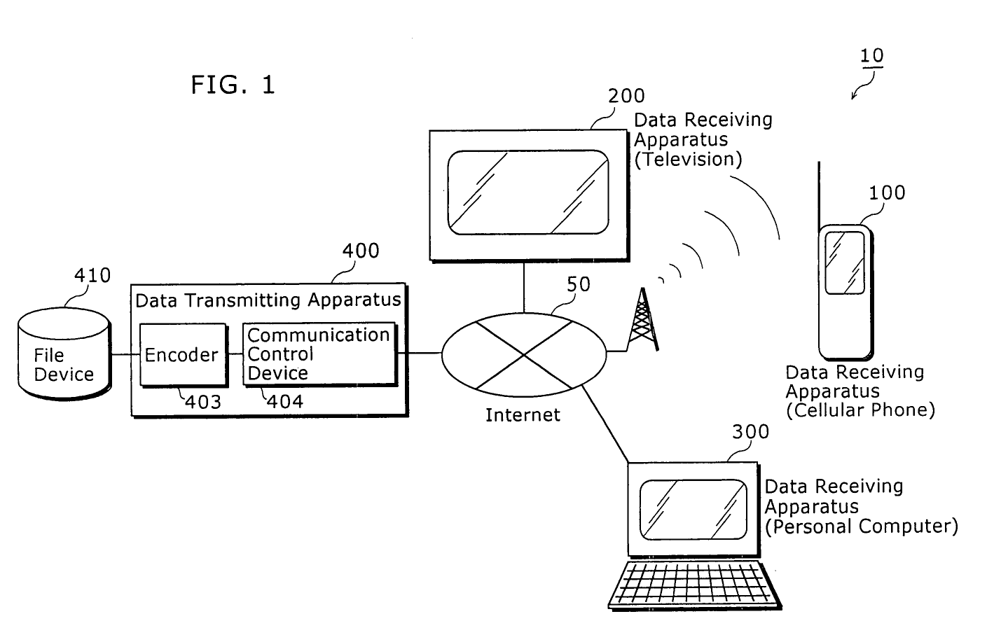

FIG. 1 is a block diagram showing an overview of a data transmitting and receiving system according to the present embodiment. A data transmitting and receiving system 10 is a system for distributing content, via Internet 50, from a data transmitting apparatus 400 to data receiving apparatuses 100 to 300 (in specific, terminal apparatuses having communication functions such as a cellular phone, a digital television and a personal computer) based on a set value for communication designated by the data receiving apparatuses. For example, when the data transmitting apparatus 400 receives an instruction about “a content identifier (e.g. content ID etc.), a compression method, and a bit rate” from the data receiving apparatus 100, a file designated by the content identifier is read, coded by the designated compression method, and distributed the coded file to the data receiving apparatus 100 at the designated bit rate. Here, a content ID is used as an example of a content identifier in the following description.

The following explains in detail about a functional structure of each apparatus.

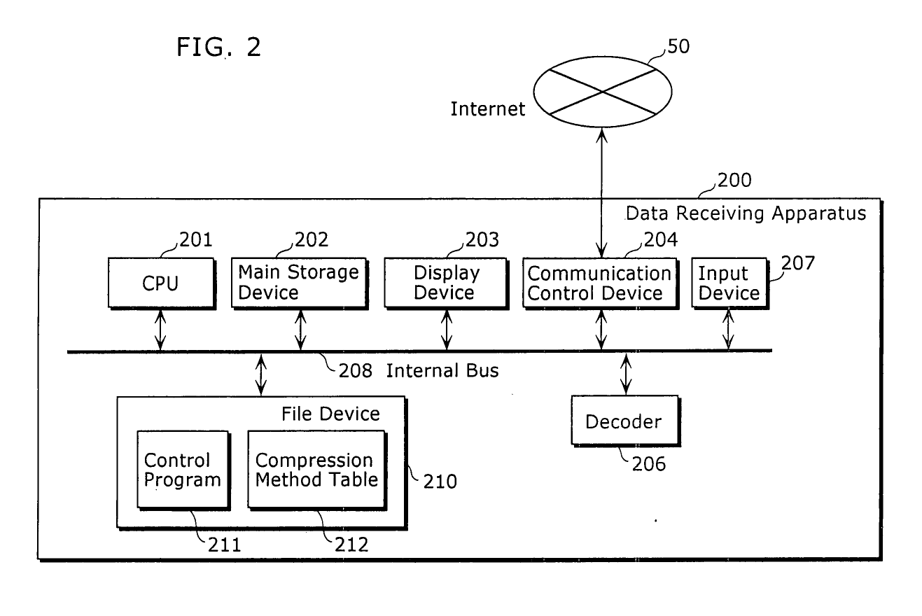

FIG. 2 is a diagram showing a hardware configuration of a data receiving apparatus 200 having a display function according to the present embodiment. The data receiving apparatus 200 is, for example, a digital television connected to the Internet 50, including a CPU 201, a main storage device 202, a display device 203, a communication control device 204, a decoder 206, an input device 207, and a file device 210. In this case, each device is mutually connected through an internal bus 208.

The CPU 201 and the main storage device 202 control the data receiving apparatus 200 as a whole based on a control program 211 stored in the file device 210. The display apparatus 203, for example, is a plasma display panel and the like. The communication control device 204 is a communication network, a control circuit and the like for receiving content, including a modem or DSU (Digital Service Unit)/TA (Terminal Adapter). The communication control device 204 is connected to the Internet 50 via a common telephone line, ISDN or the like.

The decoder 206 decodes the content received by the communication control device 204. For example, it is a MPEG-2 video decoder, an audio decoder and the like. The input device 207 is a remote control, a panel switch and the like for receiving an operation by an operator (also called as a “user”). The file device 210, for example, is a hard disk and the like which store the control program 211, a compression method table 212 and the like. The control program 211 is a program for controlling the data receiving apparatus 200 as a whole. In addition, the compression method table 212 is a table on which a compression method, a bit rate and the like are registered in association with each type of contents available for the data receiving apparatus 200.

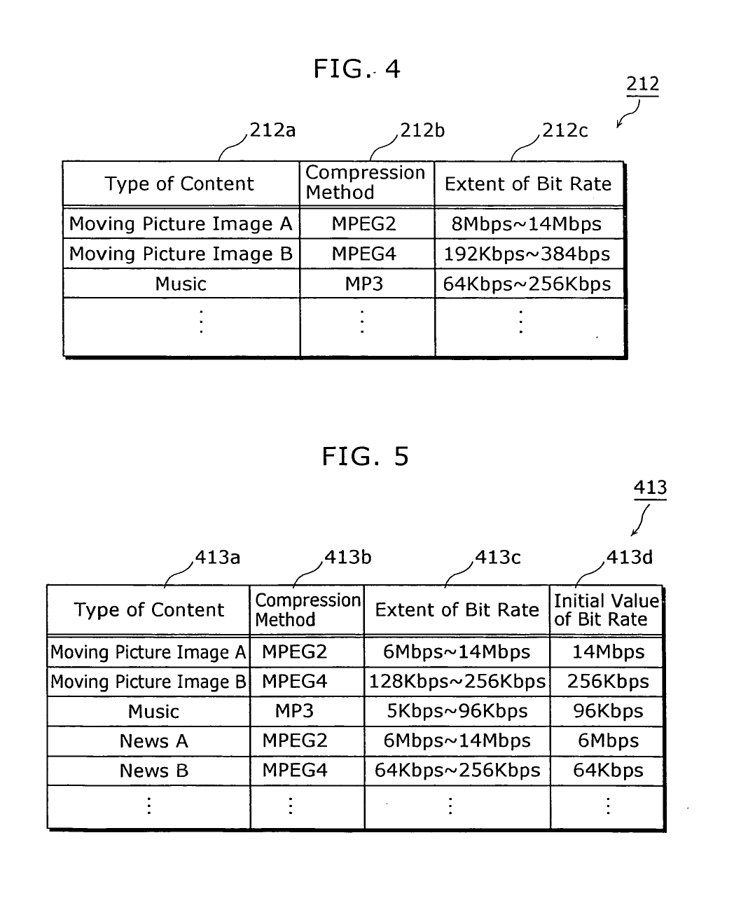

FIG. 4 is a structural example of a compression method table 212 stored in the file device 210. As shown in FIG. 4, the compression method table 212 defines, by each type of content 212a, a compression method 212b, an extent of bit rate 212c and the like. The information in the compression method table 212 is registered by an operator's operation and the like. Further, the information in the compression method table 212 is displayed on the display apparatus 203, and the compression method 212b and the extent of bit rate 212c are selected by an operation by an operator and the like. In here, FIG. 4 shows an example that defines one pair of the compression method 212b and the extent of bit rate 212c for one type of the content 212a (e.g. a moving picture image A). However, a plurality of pairs of the compression method 212b and the extent of bit rate 212c, of course, may be defined for one type of the content 212a.

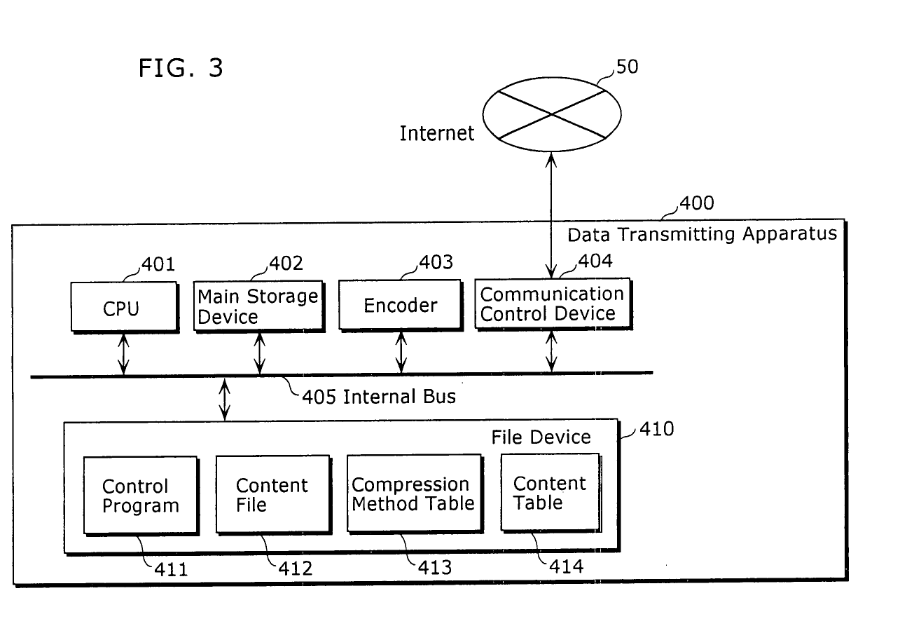

FIG. 3 is a diagram showing a hardware configuration of a data transmitting apparatus 400 according to the present embodiment. The data transmitting apparatus 400 is a content server for distributing content to a data receiving apparatus 200 and the like via the Internet 50, including a CPU 401, a main storage device 402, an encoder 403, a communication control device 404 and a file control device 410. In here, each device in the data transmitting apparatus 400 is mutually connected via the internal bus 405.

The CPU 401, the main storage device 402 and the control program 411, similar to the case of the data receiving apparatus 200, have a function of controlling the data transmitting apparatus 400 as a whole. Further, in the data transmitting apparatus 400, information indicating “a content ID (or content name)”, “a compression method”, and “an extent of bit rate” that are received from the data receiving apparatus 200 are stored in the main recording device 402 and held until the distribution of the content completes.

The encoder 403 is a coding circuit and the like for coding content to be distributed. For example, it includes a MPEG-2 video encoder and an audio encoder. The communication control device 404 is a communication network, a control circuit and the like for distributing content to the data receiving apparatus 200 and the like, the device including a modem or a DSU/TA. The communication control device 404, similar to the communication control device 204, is connected to the Internet 50.

The file device 410, for example, is a hard disk and the like, in which a control program 411, a content file 412, a compression method table 413, a content table 414 and the like are stored. In the content file 412, the substance of content is stored. In the compression method table 413, a compression method and an extent of bit rate are registered in association with each type of content. Further, in the content table 414, information and the like indicating a content name and a storage place of the content are registered corresponding to each content ID.

FIG. 5 is a structural example of the compression method table 413. As shown in FIG. 5, in the compression method table 413, a compression method 413b, an extent to bit rate 413c, an initial value of bit rate 413d and the like are defined.

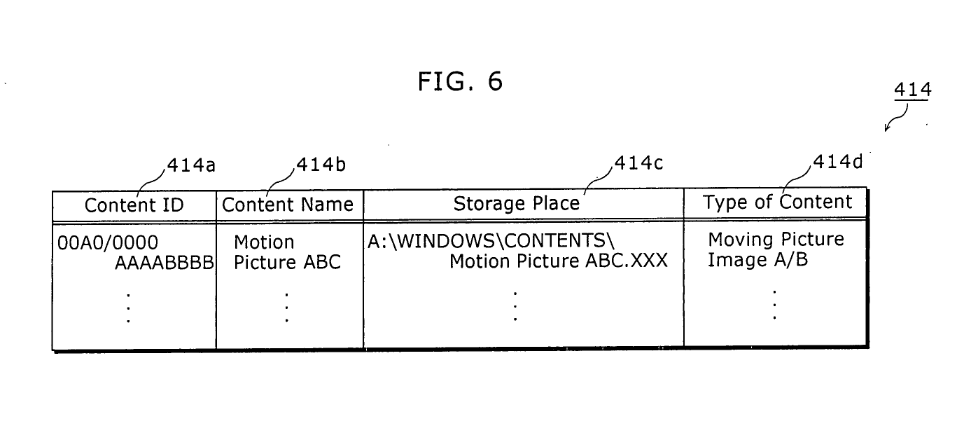

FIG. 6 is a structural example of the content table 414. As shown in FIG. 6, in the content table 414, a content name 414b, a storage place 414c, a type of content 414d and the like are defined for each content ID 414a.

Next, each function of the data receiving apparatus 200 and the data transmitting apparatus 400 is explained in detail.

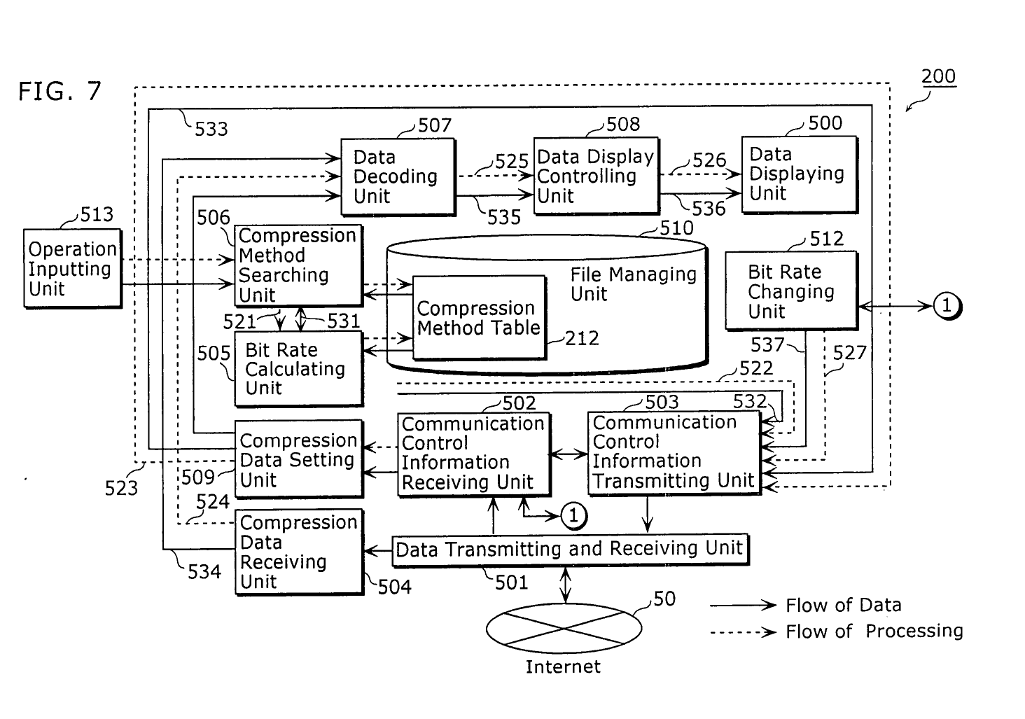

FIG. 7 is a block diagram showing a functional structure of the data receiving apparatus 200 and a flow of data. The data receiving apparatus 200, as described above, has a function of giving an instruction, to a data receiving apparatus 400, for a communication setting value such as a compression method and a bit rate when the content is received, the apparatus including a data transmitting and receiving unit 501, a communication control information receiving unit 502, a communication control information transmitting unit 503, a compression data receiving unit 504, a bit rate calculating unit 505, a compression method searching unit 506, a data decoding unit 507, a data display controlling unit 508, a compression data setting unit 509, a data displaying unit 500, a file managing unit 510, a bit rate changing unit 512, and an operation inputting unit 513.

The data transmitting and receiving unit 501 transmits and receives, via the Internet 50, content data, a control signal and the like with the data transmitting apparatus 400. In the following, the content data distributed to the data receiving apparatus 200, by the data transmitting apparatus 400, is compressed by MPEG-2, MPEG-4 or the like (hereafter referred to as “compression data”) and transmitted at a predetermined bit rate. It is assumed that the compression data includes a signal for controlling communication (hereafter referred to as “communication control information”). Also, the communication control information is transmitted from the data receiving apparatus 200 to the data transmitting apparatus 400.

The communication control information receiving unit 502 extracts, for example, communication control information from packet data received via the data transmitting and receiving unit 501 and transmits the extracted information to the compression data setting unit 509. The communication control information transmitting unit 503 i) receives a compression method and a bit rate from the bit rate calculating unit 505 and ii) adds the received information to the communication control information of the packet data to be transmitted to the data transmitting apparatus 400, and iii) transmits the added information to the data transmitting and receiving unit 501. The compression data receiving unit 504 extracts compression data from the packet data received via the data transmitting and receiving unit 501 and transmits the extracted compression data to the data decoding unit 507.

The bit rate calculating unit 505, according to an operator's operation received via the operation inputting unit 513, analyzes a processing state (e.g. state of work loads on CPU, etc.) in the data receiving apparatus 200, calculates a bit rate at which content can be received, and notifies the compression method searching unit 506. Specifically, the bit rate calculating unit 505 measures use work loads of devices (such as CPU and DSP) in the communication control information receiving unit 502, the compression data receiving unit 504, the data decoding unit 507, and the data display controlling unit 508 and calculates a bit rate at which content data at that moment can be received. Accordingly, the operator can determine an extent of bit rate at which content can be received while reviewing the calculation result.

The compression method searching unit 506, according to an operator's operation received via the operation inputting unit 513, displays a compression method on the date displaying unit 500 by searching the compression method table 511 based on a type of content and the like, and specifies a compression method and a bit rate at which content can be received in the data receiving apparatus. Further, the compression method searching unit 506 receives a notice of a value of the bit rate calculated by the bit rate calculating unit 505. Here, the specified compression method and bit rate, according to an operation by an operator, are transmitted to the communication control information transmitting unit 503.

The data decoding unit 507 decodes the compression data received via the compression data receiving unit 504 and transmits the decoded compression data to the data display controlling unit 508.

The data display controlling unit 508 displays decoded content data on the data displaying unit 500.

The compression data setting unit 509 receives a compression method, a bit rate and the like from the communication control information receiving unit 502 and transmits the received information to the data decoding unit 507. Further, the compression data setting unit 509 notifies, to the communication control information transmitting unit 503, that the compression method, bit rate and the like have been received.

The file managing unit 510, based on an instruction sent from the compression method searching unit 506 or the compression bit rate calculating unit 505, refers, searches and the like the compression method table 212.

The bit rate changing unit 512 analyzes, regularly (e.g. every 60 [sec.]) or when other applications are started, a processing state of the receiving apparatus 200 (e.g. state of work loads on CPU, etc.) and calculates a bit rate at which content can be received. Specifically, the bit rate changing unit 512 i) measures use work loads and the like of devices (such as CPU and DSP) in the communication control information receiving unit 502, a compression data receiving unit 504, a data decoding unit 507, and a data display controlling unit 508, and ii) calculates a bit rate at which the content data at that moment can be received. When the value of the bit rate is not appropriate, the bit rate changing unit 512 notifies the data transmitting apparatus 400 to request a change of the bit rate. Further, when sensing a start of each application in the data receiving apparatus 200, similar to the case described above, the bit rate changing unit 512 performs a measurement of use work loads on devices, a calculation of an appropriate bit rate, and a notice of a request of changing a bit rate. However, in these cases, only the bit rate is changed and the compression method is not changed.

The operation inputting unit 513 receives, from an operator, a content ID for specifying content and transmits the received content ID to the compression method searching unit 506. Further, an operation inputting unit 513 receives an operation from an operator for transmitting, to the data transmitting apparatus 400, the specified compression method and bit rate.

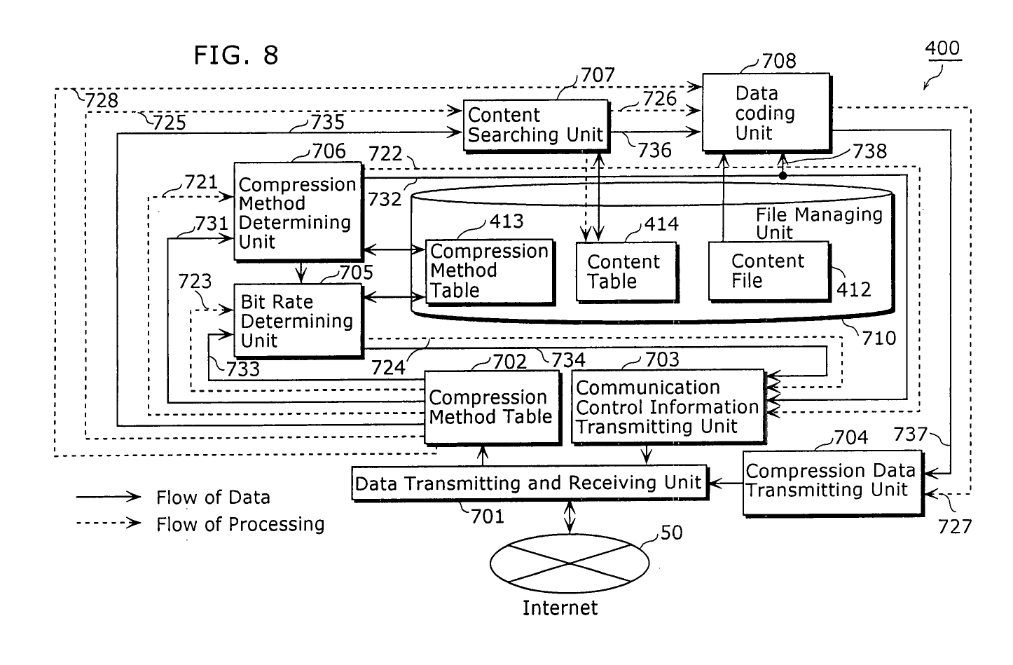

FIG. 8 is a block diagram showing a functional structure of the data transmitting apparatus 400 and a flow of data. The data transmitting apparatus 400, when, for example, receiving, from the data receiving apparatus 200, an instruction of a communication setting value such as a compression method and a bit rate as described above, has a function of distributing content to the data receiving apparatus 200 based on the communication setting value, the apparatus including a data transmitting and receiving unit 701, a communication control information receiving unit 702, a communication control information transmitting unit 703, a compression data transmitting unit 704, a bit rate determining unit 705, a compression method determining unit 706, a content searching unit 707, a data decoding unit 708 and a file managing unit 710.

The data transmitting and receiving unit 701 performs a transmission and reception of content, a control signal and the like with the data receiving apparatus 200 via the Internet 50.

The communication control information receiving unit 702 and the communication control information transmitting unit 703 function as same as the communication control information receiving unit 502 and the communication control information transmitting unit 503 in the data receiving apparatus 200 as described above.

The compression data transmitting unit 704 packets a compressed content data, a control signal and the like, and transmits the packet data to the data transmitting and receiving unit 701.

The bit rate determining unit 705 receives “a content ID, a compression method, and a bit rate” from the data receiving apparatus 200, searches the compression method table 413, judges whether or not a distribution is permitted at the bit rate and notifies the communication control information transmitting unit 703 about the judgement result if the distribution is permitted. Further, the bit rate determining unit 705 i) receives a request of changing a bit rate from the data receiving apparatus 200 via the communication control information receiving unit 702 and ii) judges whether or not the requested data is within the corresponding extent by an encoder of the data transmitting apparatus 400 with reference to the compression method table 413. When the value is within the extent, a “change determination notice” is transmitted to the data receiving apparatus 200. At this time, the bit rate determining unit 705 saves the value of the bit rate to be changed until when it is actually changed.

The compression method determining unit 706 receives “a content ID, a compression method, a bit rate” from the data receiving apparatus 200, and judges whether or not the compression method is the corresponding compression method using an encoder 403 of the data transmitting apparatus 400. When a distribution is permitted by the compression method, the compression method determining unit 706 notifies the communication control information transmitting unit 703 that a compression coding is permitted by the specified compression method.

The content searching unit 707 searches the content table 414 using the content ID received from the data receiving apparatus 200 as a search key, and notifies the data coding unit 708 when there is an applied content.

The data coding unit 708, according to the notice from the content searching unit 707, specifies content to be distributed by searching the content file 412, and transmits, to the compression data transmitting unit 704, the data of the content by coding and compressing the data.

The file managing unit 710 refers, searches and the like the compression method table 413 and the content table 414 based on an instruction by the compression method determining unit 706 or by the bit rate determining unit 705.

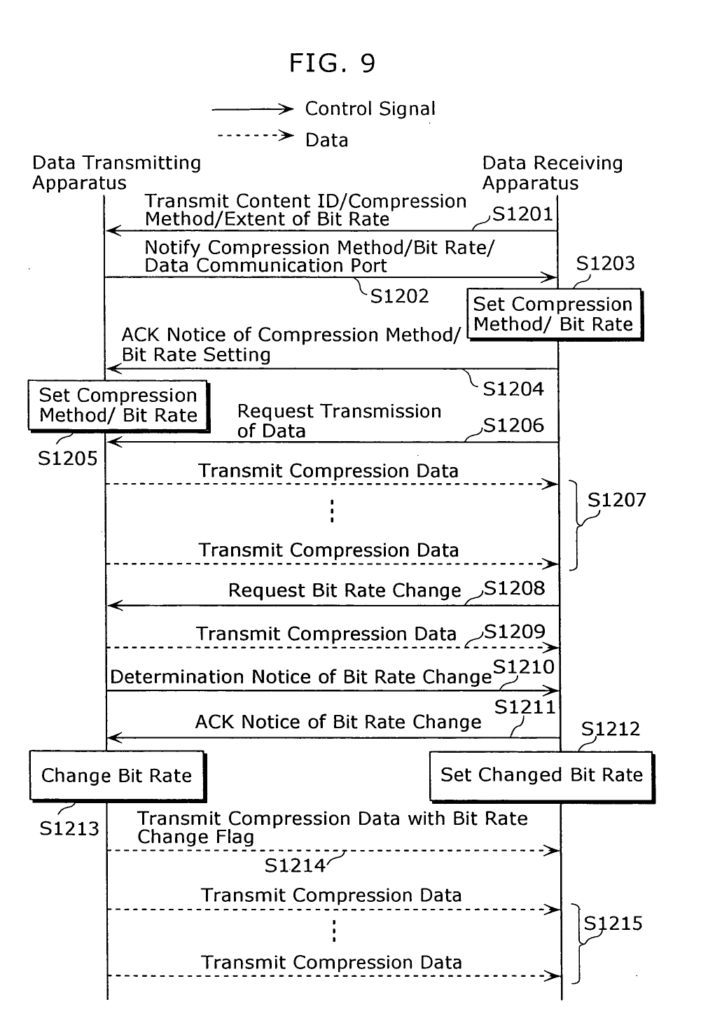

Next, a communication procedure between the data receiving apparatus 200 and the data transmitting apparatus 400 that are structured as described above is explained. FIG. 9 is a communication sequence diagram between the data receiving apparatus 200 and the data transmitting apparatus 400.

Firstly, the data receiving apparatus 200, to the data transmitting apparatus 400, transmits a content ID, a compression method and an extent of bit rate that are specified by the operator (S1201), and requests to determine the compression method and the bit rate.

In response to this, the data transmitting apparatus 400 specifies a compression method of the content, a bit rate and a communication port and sends them back to the data receiving apparatus 200 (S1202). The receiving apparatus 200 that received them sets a compression method for a bit rate and decoding to receive the content (S1203), and transmits, to the data transmitting apparatus 400, an “ACK notice” which indicates the completion of the setting (S1204). Accordingly, the data transmitting apparatus 400 performs coding using the compression method after it recognizes the reception of “a data transmission request” from the data receiving apparatus 200 (S1206) and starts transmitting data at the bit rate (1207).

If a “bit rate change request” is received from the data receiving apparatus 200 during this time (S1208), the data transmitting apparatus 400 determines the new bit rate and notifies the determined bit rate to the data receiving apparatus 200 (S1210). Accordingly, the data receiving apparatus 200 transmits, to the data transmitting apparatus 40, the “ACK notice” which indicates that changes of the compression method and the bit rate are permitted as similar to the above (S1211), and performs a setting for changing the compression method and the bit rate (S1212).

After that, the data transmitting apparatus 400 i) performs coding, using the changed compression method, the remaining contents which have not been distributed, ii) sets a “bit rate change flag” in a part of the compressed data packet (e.g. a header), and iii) restarts a distribution at the changed bit rate (S1213 to S1215). By restarting the distribution, the data receiving apparatus 200 that received the content receives the remaining contents at the changed bit rate and decodes them using the changed compression method.

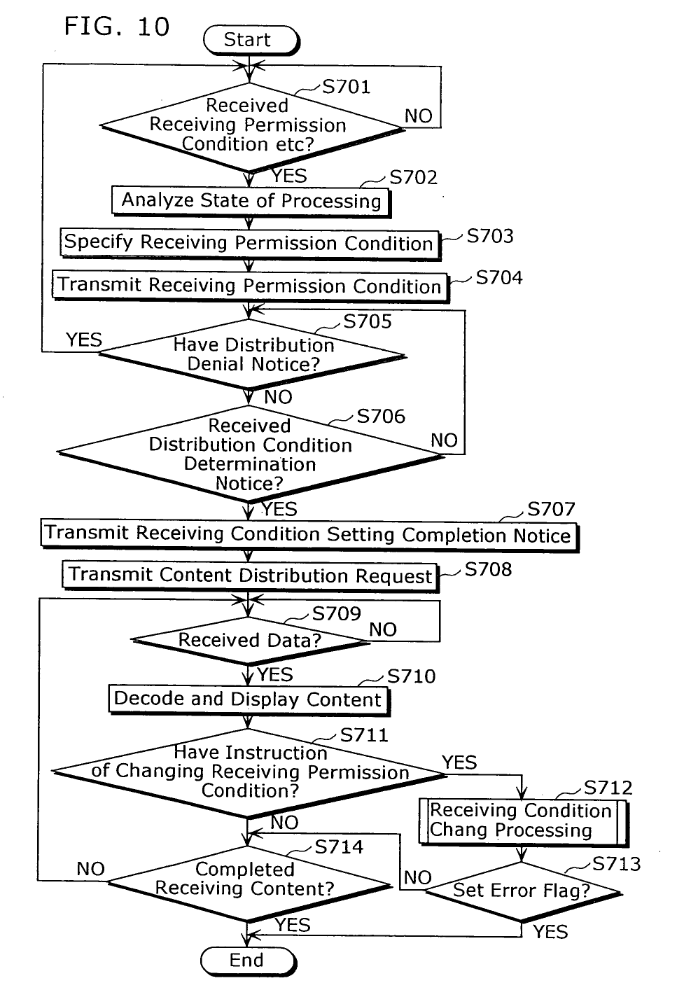

FIG. 10 is a flowchart showing a flow of processing in the data receiving apparatus 200 in the case where the communication described in FIG. 9 is performed.

Firstly, the compression method searching unit 506 receives receiving permission conditions such as a content ID, a compression method, and a bit rate from the operator via the operation inputting unit 513 (S701). Then the bit rate calculating unit 505 analyzes the processing state in the data receiving apparatus 200 (S702) and specifies the receiving permission conditions (S703), and reports the result to the communication control information transmitting unit 503. Accordingly, the communication control information transmitting unit 503 receives, via the data transmitting and receiving unit 501, a distribution condition determination notice from the data transmitting apparatus 400 (S706), notifies the reception to the compression method searching unit 506 and the bit rate calculating unit 505, a notice about the completion of the receiving condition setting (S707) and transmits a request of distributing content (S708).

On the other hand, in the case where the communication control information receiving unit 502 receives a “distribution denial notice” from the data transmitting apparatus 400 (S705), the processing is terminated.

Further, the communication control information receiving unit 502 receives content via the data transmitting and receiving apparatus 501 (S709) and transmits the received content to the compression data setting unit 509. The received content is displayed on the data displaying unit 500 via the data decoding unit 507 and the data display controlling unit 508.

Here, the bit rate changing unit 512 regularly (e.g. every 60 [sec.]) monitors the processing state in the data receiving apparatus 200, performs a “receiving condition change processing” (S712) when the bit rate has to be changed (e.g. when an application software is newly started), changes the value of the bit rate and continues the reception of content (S709 to S714) when an error flag is not set (S713).

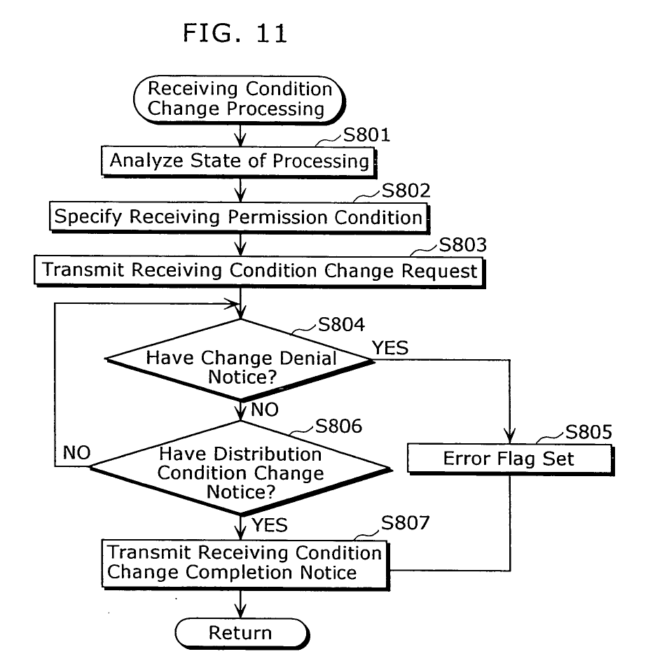

FIG. 11 is a flowchart of the “receiving condition change processing” described in FIG. 10. The purpose of the processing shown in FIG. 11 is i) to monitor the processing state of each processing block in the data receiving apparatus 200 shown in FIG. 7 and control a distribution of the processing loads according to its capacity, and ii) to change the processing loads on each processing block by changing a bit rate of a compression data.

Firstly, the bit rate changing unit 512 analyzes the processing state in the data receiving apparatus 200 (S801), specifies new receiving permission conditions (e.g. a bit rate) (S802), and transmits a “receiving condition change request” to the data transmitting apparatus 400 via the communication control information transmitting unit 503 (S803). For example, the bit rate changing unit 512, at every 60 seconds and at a predetermined time (e.g. for 0.1 second), calculates a CPU holding time (“time A”) in the data transmitting and receiving unit 501, the communication control information receiving unit 502, the compression data receiving unit 504, the compressing data setting unit 509 and the data display controlling unit 508. When a new application is started during the calculation, the total of the CPU holding time of the application at a predetermined time (e.g. for 0.1 second) is calculated (“time B”). If the ratio of time A and time B is 1:1, the value of the new bit rate is changed to half of the original value.

Here, other than calculating the CPU holding time, the bit rate changing unit 512 may monitor a state of using a buffer for a transmission and a reception, and calculates state of use of a new bit rate according to the amount of free space in the buffer (e.g. when the amount of the free space of the buffer is under 50%, the value of the bit rate is changed to half of the original value). Also, when each processing block shown in FIG. 11 is processed by a specific processor, the bit rate changing unit 512 may judge whether or not there is room in the data processing.

Thus, the bit rate changing unit 512 has a function of operating regularly and a function of operating irregularly at the timing such as when an application is started, when an event is detected causing an increase or a decrease of the processing loads. Therefore, the processing loads on the data receiving apparatus can be measured effectively and the amount of data communication can be switched to the amount in compliance with the processing capacity of the data receiving apparatus at different times.

Next, the bit rate changing unit 512 receives, via the communication control information receiving unit 502, the “distribution condition change notice” from the data transmitting apparatus 400, transmits a notice of the “receiving condition change completion” to the data transmitting apparatus 400 (S807), and returns to the routine of the processing.

In here, if the data transmitting apparatus 400 transmits a “distribution denial notice”, an “error flag” is set (S805), and returns to the routine of the processing.

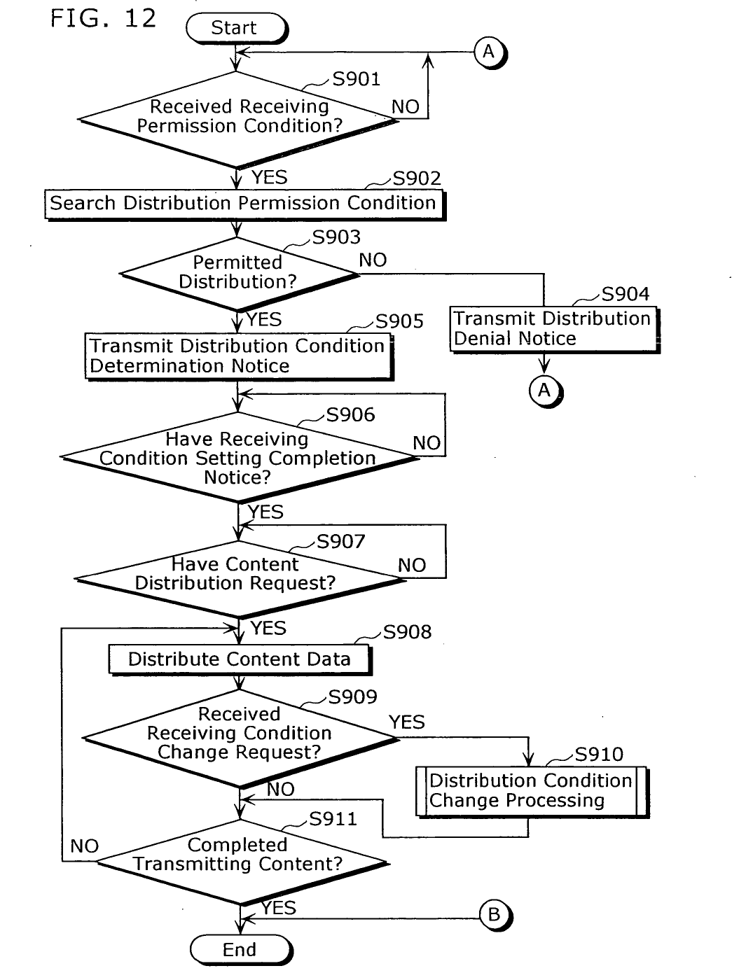

FIG. 12 is a flowchart showing a flow of processing in the data transmitting apparatus 400 when it performs communication shown in FIG. 9.

Firstly, the compression method determining unit 706 receives, via the communication control information receiving unit 702, the receiving permission condition from the data receiving apparatus 200 (S901), searches the compression method table 413 based on the received receiving permission condition, judges whether or not the specified content can be distributed by the specified compression method and at the bit rate (S903), transmits, to the data receiving apparatus 200, the “distribution condition determination notice” when the distribution is permitted (S905) and transmits the “distribution denial notice” when the distribution is denied (S904).

Next, the compression method determining unit 706 i) receives, via the communication control information receiving unit 502, the “receiving condition setting completion notice” and the “content distribution request” from the data receiving apparatus 200 (S906, S907), ii) provides an instruction about the timing to restart the compression coding to the data decoding unit 708 and an instruction, to the communication control information transmitting unit 703, of transmitting data coded by the changed bit rate, and iii) starts the distribution of content (S908).

During this time, the compression method determining unit 706 receives, via the communication control information receiving unit 702, the “receiving condition change request” from the data receiving apparatus 200 and executes the distribution condition change processing (S910).

The compression method determining unit 706 continues the above mentioned processing until a distribution of content completes (S908 to S911).

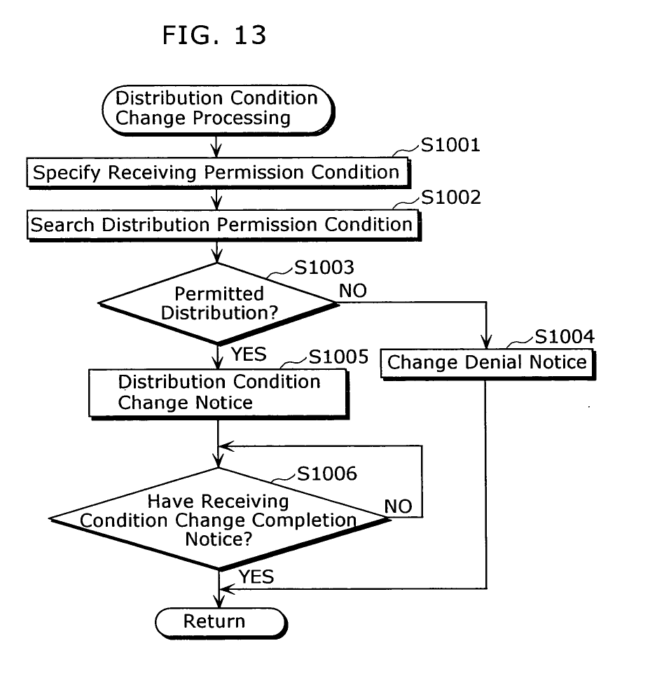

FIG. 13 is a flowchart of the “distribution condition change processing” shown in FIG. 12.

Firstly, the compression method determining unit 706 receives the “receiving condition change notice” via the communication control information receiving unit 702, specifies the receiving permission condition of the data receiving apparatus 200 from the content of the notice (S1001), and judges whether or not a distribution condition can be changed under the specified conditions with reference to the compression method table 413 (S903).

When a change is permitted (Yes at S903), the compression method determining unit 706 transmits the “distribution condition change notice” to the data receiving apparatus 200 (S1005), waits to receive the “receiving condition setting completion notice” from the data receiving apparatus 200 (S1006) and returns to the routine of the processing.

On the other hand, when the change is denied (No at S903), the compression method determining unit 706 transmits the “change denial notice” to the data receiving apparatus 200, and returns to the routine of the processing (S1004).

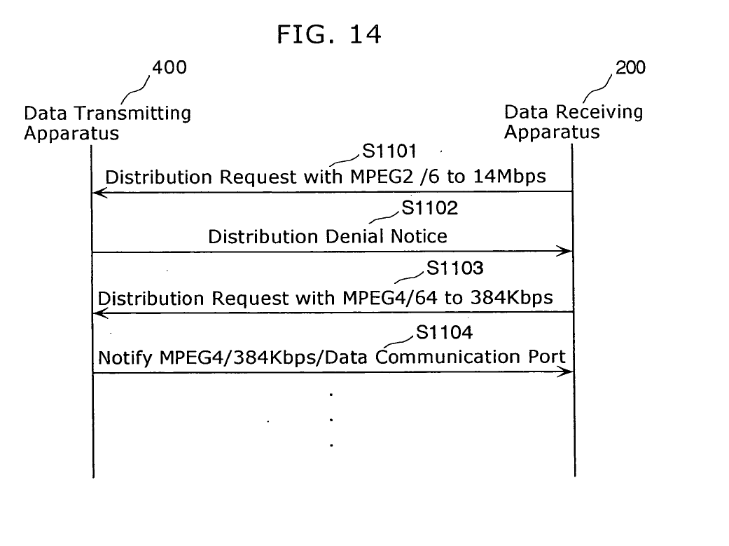

FIG. 14 is a communication sequence diagram showing interactions in the case where the data receiving apparatus 200 specifies a compression method and a bit rate again due to the failure of distributing content from the data transmitting apparatus 400 by the compression method and at the bit rate specified for the first time by the data receiving apparatus 200. FIG. 14 shows that the distribution can be permitted by indicating a different communication setting value in the case where the content cannot be distributed by the first instruction from the data receiving apparatus 200.

As described above, according to the data transmitting and receiving system 10 in the present embodiment, the data receiving apparatus designates a receiving condition in accordance with its own capacity and the like, and receives content so that it can more certainly receive a distribution of the content. Further, in the data transmitting and receiving system 10, when a processing state in the data receiving apparatus is changed, a distribution can be received by changing a bit rate and the like so that a communication error on the distribution can be avoided. Furthermore, in the present data transmitting and receiving system 10, a distribution is performed after the compression coding by the compression method specified by the data receiving apparatus so that the content compressed and coded by each compression method does not need to be prepared in advance and the size of storage capacity of the data transmitting apparatus can be minimized.

Here, in the first embodiment, it is explained that a compression method and an extent of bit rate are specified in the compression method searching unit 506. However, a compression method only can be specified in the compression method searching unit 506 and a unique bit rate can be specified at the bit rate calculating unit 505.

Further, in the first embodiment, as information for determining a value of a communication setting from the data receiving apparatus to the data transmitting apparatus, an example for transmitting the compression method and the extent of the bit rate at once is explained. However, either one of the compression method or the extent of the bit rate can be transmitted. Further, in this case, not the extent of bit rate, but only the bit rate can be transmitted.

### Second Embodiment

In the first embodiment, it is explained about the data transmitting and receiving system including the data receiving apparatus having a display function. In the present embodiment, it is explained about a date transmitting and receiving system having a data recording function.

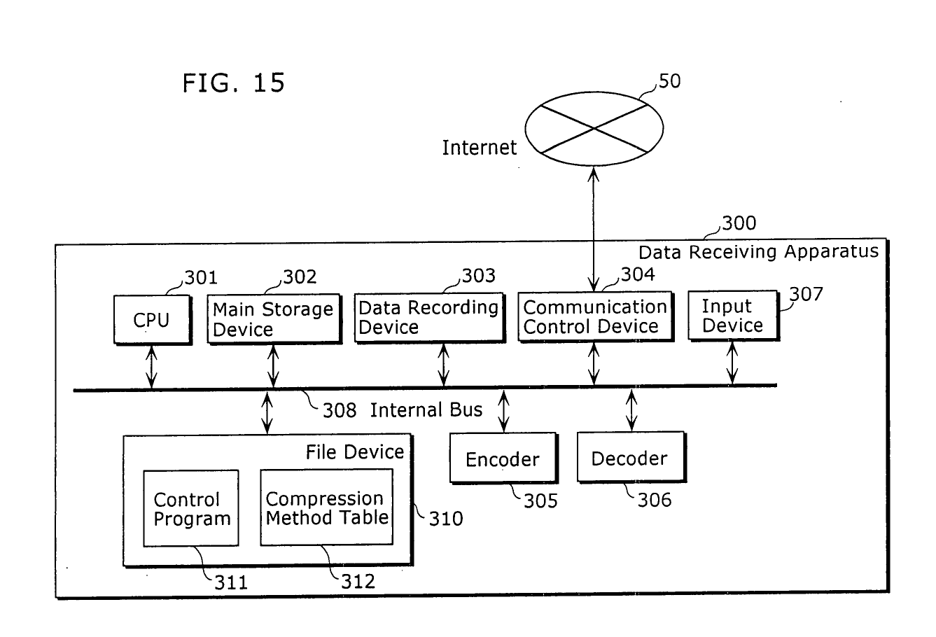

FIG. 15 is a diagram showing a hardware configuration of the data receiving apparatus 300 in a data transmitting and receiving system 20 (not shown in the diagram) according to the second embodiment. The difference between the data receiving apparatus 200 in the first embodiment and the present data receiving apparatus 300 is that the data receiving apparatus 300 has a data recording device 303 instead of the displaying device 203 and newly has an encoder 305.

The data recording device 303 is a data storage device for recording video content, music content and the like by compressing them. For example, it is a DVD device.

The encoder 305 is a coding device for compressing the content and the like to be recorded onto the data recording device 303. For example, it is a MPEG-2 encoder.

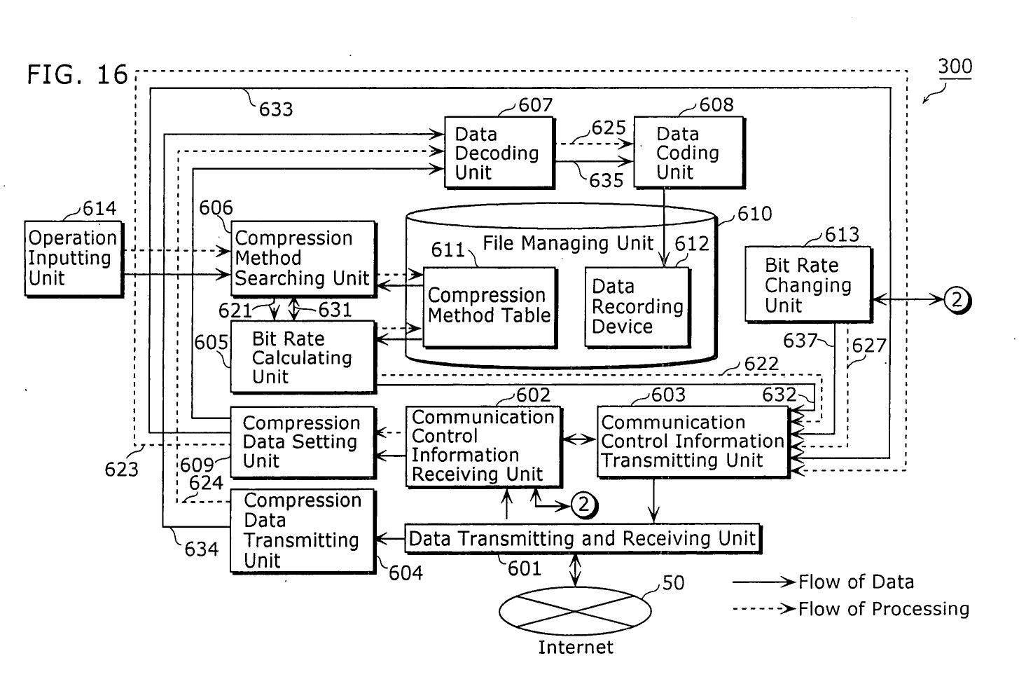

FIG. 16 is a block diagram showing a functional structure of the data receiving apparatus 300 and a flow of data in the second embodiment. The difference between FIG. 7 in the first embodiment and FIG. 16 is that the data receiving apparatus 300 has a data coding unit 608 in place of the data display controlling unit 508 and the data displaying unit 500 and that a data recording device is added as a management target of the file managing unit 610.

The data coding unit 608 performs compressed coding of data received from the data decoding unit 607 and stores the data into the data storage device 303. In addition to the function of the file managing unit 510 in the first embodiment, the file managing unit 610 performs a storing and the like of content into the data storage device 303 based on an instruction from the data coding unit 608.

Other functions are similar to each corresponding function shown in FIG. 7 of the first embodiment.

As described above, according to the data transmitting and receiving system 20 of the present embodiment, the data receiving apparatus receives content by specifying a receiving condition in accordance with its own capacity and the like so that the more certain distribution of content becomes available. Further, in the data transmitting and receiving system 20, when a processing state is changed in the data receiving apparatus, a distribution can be received by changing a bit rate and the like so that a communication error during the distribution can be avoided. Furthermore, according to the present data transmitting and receiving system 20, data is distributed after the data is compressed and coded by the compression method specified by the data receiving apparatus. Therefore, the content does not need to be compressed and coded by each compression method in advance so that a size of the recording capacity of the data transmitting apparatus is miniaturized.

### INDUSTRIAL APPLICABILITY

As described above, a data transmitting apparatus, a data receiving apparatus, a data transmitting method and a data receiving method according to the present invention is applicable to a communication system for transmitting and receiving content such as video and audio between a content server and a communication terminal, in particular to a case where a specification of set value for communication at the communication terminal is restricted, compared to that at the content server.

1. A data transmitting apparatus that distributes a predetermined digital content to a data receiving apparatus in response to a request from the data receiving apparatus, comprising:
a communication setting value receiving unit operable to receive, from the data receiving apparatus, information for determining a communication setting value that indicates a rule for performing communication;
a communication setting value determining unit operable to determine a communication setting value for a distribution of the digital content based on the received information;
a communication setting value transmitting unit operable to transmit the determined communication setting value to the data receiving apparatus; and
a data transmitting unit operable to transmit the digital content to the data receiving apparatus in accordance with the determined communication setting value.

2. The data transmitting apparatus according to claim 1,
wherein the communication setting value receiving unit further receives, from the data receiving apparatus, information for changing the communication setting value halfway through the transmission of the digital content,
the communication setting value determining unit further changes the communication setting value based on the received information for changing the communication setting value, and
the data transmitting unit further transmits the rest of the digital content halfway through the transmission according to the changed communication setting value.

3. The data transmitting apparatus according to claim 2,
wherein the data transmitting unit further adds, to a part of the digital content which has not been transmitted by said transmission, information indicating that the communication setting value has been changed.

4. The data transmitting apparatus according to claim 2,
wherein the communication setting value receiving unit receives information indicating a candidate for the communication setting value as information for determining or changing the communication setting value, and
the communication setting value determining unit determines a unique communication setting value based on the received information indicating the candidate.

5. The data transmitting apparatus according to claim 4,
wherein the information for determining or changing the communication setting value is information indicating a compression method for coding the digital content.

6. The data transmitting apparatus according to claim 4,
wherein the information for determining or changing the communication setting value is information indicating a bit rate for transmitting the digital content.

7. The data transmitting apparatus according to claim 4,
wherein the information for determining or changing the communication setting value is information indicating a compression method for coding the digital content and a bit rate for transmitting the digital content.

8. The data transmitting apparatus according to claim 7, further comprising a storing unit operable to store transmission related information concerning a specification and a performance of the data transmitting apparatus, the information being used for determining or changing the communication setting value,
wherein the communication setting value determining unit further determines the unique communication setting value based on the received information for determining or changing the communication setting value and the transmission related information, and transmits a distribution denial notice to the data receiving apparatus in the case where said determination cannot be made.

9. A data receiving apparatus that receives a distribution of a digital content from a data transmitting apparatus, comprising:
a communication setting value transmitting unit operable to transmit, to the data transmitting apparatus, information for determining a communication setting value that indicates a rule for performing communication;
a communication setting value receiving unit operable to receive the communication setting value from the data transmitting apparatus; and
a data receiving unit operable to receive digital content from the data transmitting apparatus in accordance with the received communication setting value.

10. The data receiving apparatus according to claim 9, further comprising a processing state analyzing unit operable to analyze a processing load state in the apparatus,
wherein the communication setting value transmitting unit further specifies information for changing the communication setting value based on the analyzed processing load state and transmits the specified information to the data transmitting apparatus halfway through the reception of the digital content,
the communication setting value receiving unit further receives information indicating the changed communication setting value from the data transmitting apparatus, and
the data receiving unit further receives the rest of the digital content halfway through the reception according to the received information indicating the changed communication setting value.

11. The data receiving apparatus according to claim 10,
wherein the processing state analyzing unit analyzes the processing load state based on a CPU occupancy time.

12. The data receiving apparatus according to claim 10,
wherein the processing state analyzing unit analyzes the processing load state based on a state of vacancy of a transmitting and receiving buffer.

13. The data receiving apparatus according to claim 10,
wherein the communication setting value transmitting unit transmits information indicating a candidate for the communication setting value as information for determining or changing the communication setting value, and
the communication setting value receiving unit receives a unique communication setting value from the data transmitting apparatus.

14. The data receiving apparatus according to claim 13,
wherein the information for determining or changing the communication setting value is information indicating a compression method used by the data transmitting apparatus to code the digital content.

15. The data receiving apparatus according to claim 13,
wherein the information for determining or changing the communication setting value is information indicating a bit rate used by the data transmitting apparatus to transmit the digital content.

16. The data receiving apparatus according to claim 13,
wherein the information for determining or changing the communication setting value is information indicating:
a compression method used by the data transmitting apparatus to code the digital content; and
a bit rate used by the data transmitting apparatus to transmit the digital content.

17. The data receiving apparatus according to claim 16, further comprising a storing unit operable to store receiving related information concerning a specification and a performance of the data receiving apparatus, the information being used for determining or changing the communication setting value,
wherein the communication setting value receiving unit further performs the followings in the case where a distribution denial notice indicating that a communication setting value cannot be determined is received: i) specifying, from the data transmitting apparatus, a candidate for a communication setting value with which communication can be performed with reference to the storing unit; and ii) transmitting information indicating the candidate to the data transmitting apparatus.

18. The data receiving apparatus according to claim 17,
wherein the data receiving unit further performs the followings in the case where information indicating that the communication setting value has been changed is added to a part of the received digital content: i) changing the communication setting value based on said information; and ii) receiving the rest of the received digital content in accordance with the changed communication setting value.

19. A data transmitting method for distributing a predetermined digital content to a data receiving apparatus in response to a request from the data receiving apparatus, the method comprising:
a communication setting value receiving step of receiving, from the data receiving apparatus, information for determining a communication setting value which indicates a rule for performing communication;
a communication setting value determining step of determining a communication setting value according to a distribution of the digital content based on the received information;
a communication setting value transmitting step of transmitting the determined communication setting value to the data receiving apparatus; and
a data transmitting step of transmitting the digital content to the data receiving apparatus in accordance with the determined communication setting value.

20. A data receiving method for receiving a distribution of a digital content from a data transmitting apparatus, the method comprising:
a communication setting value transmitting step of transmitting, to the data transmitting apparatus, information for determining a communication setting value which indicates a rule for performing communication;
a communication setting value receiving step of receiving information indicating the communication setting value from the data transmitting apparatus; and
a data receiving step of receiving digital content from the data transmitting apparatus according to the communication setting value in compliance with the received information.

21. A data transmitting and receiving method for transmitting a predetermined digital content from a data transmitting apparatus to a data receiving apparatus in response to a request from the data receiving apparatus, the method comprising:
a communication setting value transmitting step executed by a data receiving apparatus, of transmitting, to a data transmitting apparatus, information for determining a communication setting value;
a communication setting value receiving step executed by the data transmitting apparatus, of receiving, from the data receiving apparatus, said information for determining the communication setting value;
a communication setting value determining step executed by the data transmitting apparatus, of determining a communication setting value based on the received information for determining the communication setting value and of transmitting, to the data receiving apparatus, information indicating the determined communication setting value;
a determination information receiving step executed by the data receiving apparatus, of receiving the information indicating the determined communication setting value;
a data transmitting step executed by the data transmitting apparatus, of transmitting the digital content to the data receiving apparatus in accordance with the determined communication setting value; and
a data receiving step executed by the data receiving apparatus, of receiving the digital content from the data transmitting apparatus according to the information indicating the determined communication setting value.
